(19) United States
(12) Patent Application Publication
(10) Pub. No.: US 2024/0420514 A1
(43) Pub. Date: Dec. 19, 2024

(54) VEHICLE-GENERATED DATA MANAGEMENT SYSTEM

(71) Applicant: International Business Machines Corporation, Armonk, NY (US)

(72) Inventors: Hyman David Chantz, Scarsdale, NY (US); Pascal R. Bastien, Poughkeepsie, NY (US); David Horsfield, New York, NY (US); Justin Rosenthal, Hewlett Harbor, NY (US)

(21) Appl. No.: 18/334,479

(22) Filed: Jun. 14, 2023

(51) Int. Cl. G07C 5/00; G08G 1/00

(52) U.S. Cl. CPC G07C 5/008; G08G 1/20

(57) ABSTRACT

Computer-implemented methods for a vehicle-generated data management system. Aspects include receiving vehicle-generated data from a vehicle associated with a vehicle-generated data management system. Aspects further include processing the vehicle-generated data to extract sensor data, GPS data, and time data. Aspects further include generating situational data using the sensor data, the GPS data and the time data. Aspects further include transmitting the situational data and the processed vehicle-generated to a hybrid cloud system.

### BACKGROUND

The present invention generally relates to vehicle-generated data, and more specifically, to computer systems, computer-implemented methods, and computer program products for a vehicle-generated data management system.

Advancement of technology has enabled devices, such as vehicles, to generate many different types of data. For example, vehicles are capable of generating, receiving, and transmitting a wide variety of data, such as video from cameras of the vehicle, location data from GPS systems, and the like. Most data collected from on-board vehicle sensors are not stored or streamed. The data that is collected or generated by the sensors is often temporarily used by one or more computing systems of the vehicle and then overwritten or deleted. Sensors of the vehicle are capable of continuously generating considerable quantities of data, the data is often not utilized by the vehicle or its associated computing systems.

### SUMMARY

Embodiments of the present invention are directed to a computer-implemented method for a vehicle-generated data management system. According to an aspect of the invention, a computer-implemented method includes receiving vehicle-generated data from a vehicle associated with a vehicle-generated data management system. The method also includes processing vehicle-generated data to extract sensor data, GPS data, and time data. The method further includes generating situational data using the sensor data, the GPS data and the time data. The method also includes transmitting the situational data and the processed vehicle-generated to a hybrid cloud system.

In one embodiment of the present invention, the method further includes intercepting sensor data from a sensor of the vehicle and generating vehicle-generated data by associating the sensor data with a current time and a current GPS location of the vehicle.

In one embodiment of the present invention, the method further includes transmitting a request for the vehicle-generated data from the vehicle and receiving the vehicle-generated data from the vehicle in response to the request. The method also includes receiving a notification that the vehicle is in an identified geographic area. The method further includes transmitting the request for the vehicle-generated data of the vehicle in response to receiving the notification.

In one embodiment of the present invention, the method further includes receiving a request for data associated with an identified location from a user device. The method also includes retrieving a set of processed vehicle-generated data from the hybrid cloud system. In response to the request, the method includes generating new situational data using the set of processed vehicle-generated data. The method further includes transmitting the new situational data to the user device.

In one embodiment of the present invention, processing the vehicle-generated data further includes analyzing content of the vehicle-generated data, extracting the sensor data, the GPS data, and the time data from the vehicle-generated data, and associating one or more category tags with the vehicle-generated data.

In one embodiment of the present invention, the method further includes receiving additional vehicle-generated data from a different vehicle. The method includes processing the additional vehicle-generated data. The method further includes generating additional situational data using the additional vehicle-generated data. The method also includes generating a set of situational data comprising the situational data and the additional situational data based on an identified GPS location or an identified time. The method further includes transmitting the set of situational data to the hybrid cloud system.

According to another non-limiting embodiment of the invention, a system having a memory having computer readable instructions and one or more processors for executing the computer readable instructions, the computer readable instructions controlling the one or more processors to perform operations. The operations include receiving vehicle-generated data from a vehicle associated with a vehicle-generated data management system. The operations further include processing vehicle-generated data to extract sensor data, GPS data, and time data. The operations also include generating situational data using the sensor data, the GPS data and the time data. The operations further include transmitting the situational data and the processed vehicle-generated to a hybrid cloud system.

According to another non-limiting embodiment of the invention, a computer program product for adaptive, personalized system for managing training compliance is provided. The computer program product includes a computer-readable storage medium having program instructions embodied therewith, the program instructions executable by a processor to cause the processor to perform operations. The operations include receiving vehicle-generated data from a vehicle associated with a vehicle-generated data management system. The operations further include processing vehicle-generated data to extract sensor data, GPS data, and time data. The operations also include generating situational data using the sensor data, the GPS data and the time data. The operations further include transmitting the situational data and the processed vehicle-generated to a hybrid cloud system.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts a block diagram of an example computer system for use in conjunction with one or more embodiments of the present invention;

FIG. 2 is a block diagram of a system for a vehicle-generated data management system in accordance with one or more embodiments of the present invention;

FIG. 3 is a flowchart of a method for generating vehicle-generated data for a vehicle-generated data management system in accordance with one or more embodiments of the present invention; and

FIG. 4 is a flowchart of a method for generating situational data using vehicle-generated data for a vehicle-generated data management system in accordance with one or more embodiments of the present invention.

### DETAILED DESCRIPTION

As discussed above, vehicles often generate, transmit, and receive a wide variety of data. Various sensors within a vehicle are constantly capturing or generating large quantities of data. The data from the sensors are often temporarily used and then overwritten or deleted. The data is often not stored or streamed. In some embodiments, vehicle-generated can be the utilization, leveraging, and optimization of various vehicle-generated, transformed, captured, and/or acquired data.

Disclosed herein are methods, systems, and computer program products for a vehicle-generated data management system which can leverage the vehicle-generated data from one or more vehicles for other purposes, such as public safety, operational optimization, and the like. The data generated and not utilized by the vehicle can be acquired by the vehicle-generated data management system, processed, and repurposed to benefit other industries or monetized.

In an exemplary embodiment, a vehicle with many different types of sensors is associated with a vehicle-generated data management system. The vehicle has a component that is inserted into one or more sensory acquisition chains of the vehicle, enabling the component to passively collect or intercept data from the sensors and generate vehicle-generated data. The vehicle-generated data includes data from the sensor, a location obtained from a GPS of the vehicle, and a current time of the vehicle when the data was collected. The vehicle-generated data can be transmitted by the component to the vehicle-generated data management system, which can process the vehicle-generated data and generate situational data based on the vehicle-generated data. The situational data and the processed vehicle-generated data are then made available for users requesting the data.

Situational data can be generated from vehicle-generated data from one or more devices associated with the vehicle-generated data management system. Situational data is generated by applying one or more machine learning or artificial intelligence techniques to transform the raw sensor data of the vehicle-generated data into informational data that can be leveraged for other purposes by other users and/or systems.

In one example, most vehicles are equipped with backup cameras. Typically, the cameras provide a mirror-image of their input to a driver's screen. The backup cameras often do not transmit video when the vehicle is moving in a forward direction. However, the cameras are capable of providing an internal video stream while the vehicle is moving forward. The video stream from the backup camera of the vehicle can be intercepted by a component of the vehicle associated with the vehicle-generated data management system. The video stream from the backup camera and the current GPS coordinates of the vehicle are used to generate vehicle-generated data that is then transmitted from the vehicle to the vehicle-generated data management system. The vehicle-generated data is then processed and situational data is generated based on the received vehicle-generated data.

A mobile application vendor requests situational data from the vehicle-generated data management system for an identified geographic location, such as the outdoor seating of a restaurant. The mobile application vendor requests data that can be used to determine whether there are available tables in the outdoor seating area of the restaurant. The vehicle-generated data management system identifies vehicle-generated data that was collected near the outdoor seating area and identifies the vehicle-generated data (e.g., video stream) collected from the vehicle and uses the vehicle-generated data to generate situational data that can be used by the mobile application vendor. For example, the vehicle-generated data management system uses computer vision techniques to identify tables (e.g., polygon recognition) and activity of the tables by determining the density of what is on the tables or density of the objects around then in the video stream extracted from the vehicle-generated data received from the vehicle. A record of which tables are available at the outdoor seating area of the restaurant can then be generated and made available to the mobile application vendor.

Although described in the context of vehicles, the systems and methods disclosed herein can be used by a variety of user devices that have one or more sensors capable of detecting or generating data and determining a current geographic location of the device and transmitting the data to the vehicle-generated data management system for further processing. The data that is generated by the vehicle-generated management system can be utilized by public health and law enforcement agencies as well as for possible monetization to data consumers.

Various aspects of the present disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

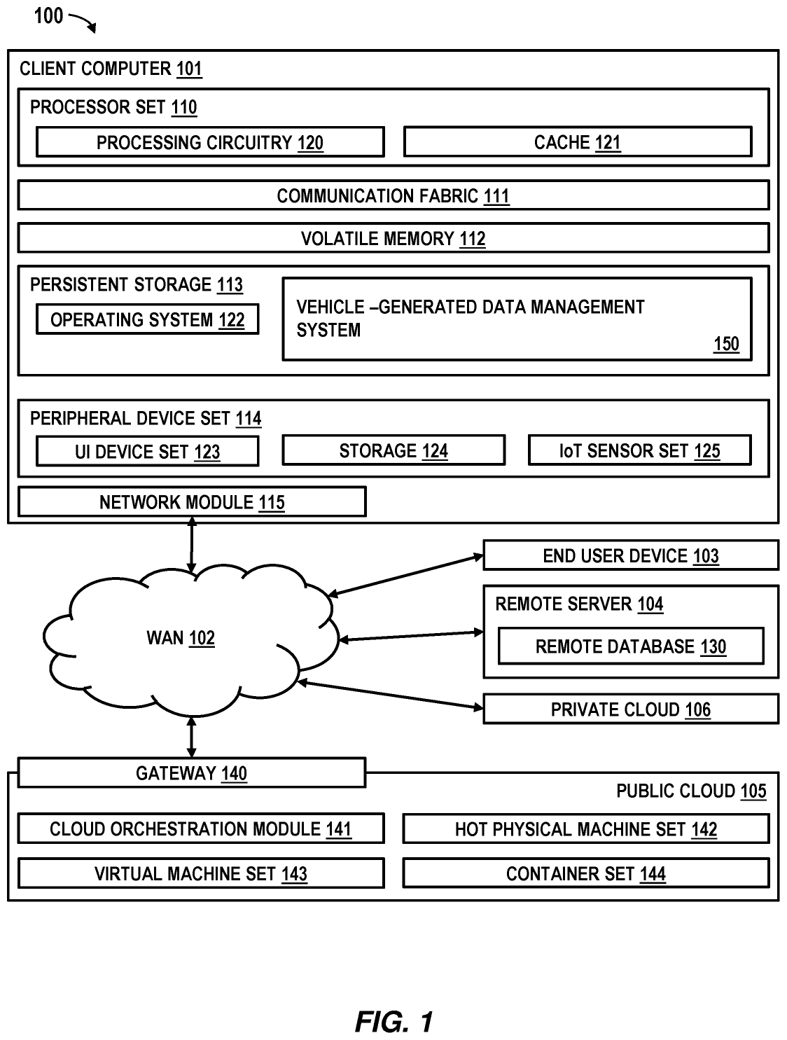

Referring now to FIG. 1, computing environment 100 contains an example of an environment for the execution of at least some of the computer code involved in performing the inventive methods, such as managing and generating data for a vehicle-generated data management system 150. In addition to vehicle-generated data management system 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and vehicle-generated data management system 150, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Client computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in the vehicle-generated data management system 150 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface type operating systems that employ a kernel. The code included in the vehicle-generated data management system 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collects and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

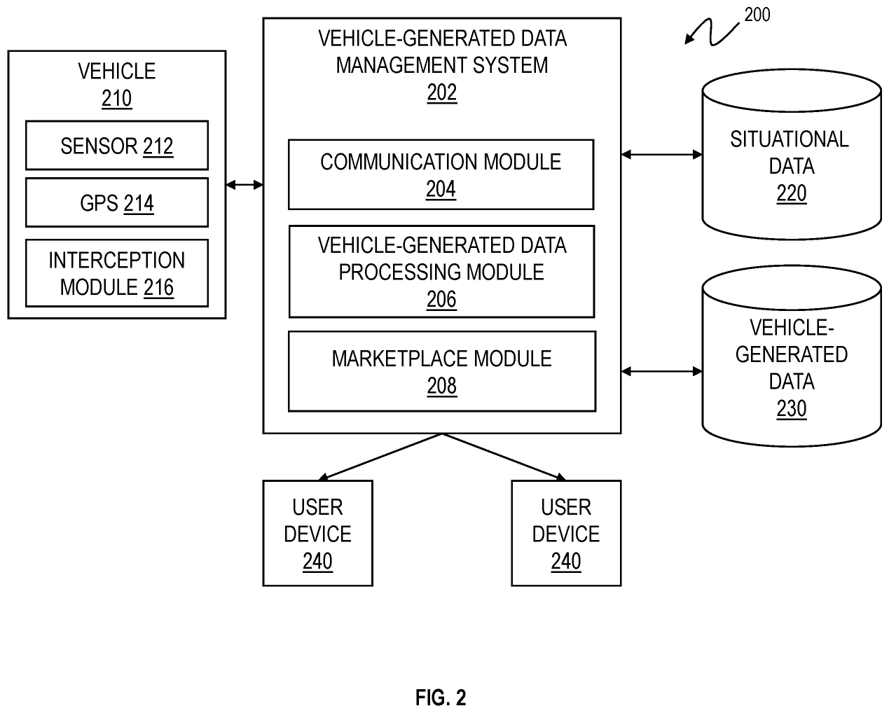

Referring now to FIG. 2, a system 200 for vehicle-generated data management system in accordance with one or more embodiments of the present invention is shown. In exemplary embodiments, the system 200 includes a vehicle-generated data management system 202 that may be embodied in a computer 101, such as the one shown in FIG. 1. As illustrated, the system 200 includes a vehicle-generated data management system 202 that is associated with one or more vehicles 210. The vehicle-generated data management system 202 is configured to receive and process vehicle-generated data 230 from one or more vehicles 210, generate and manage situational data 220, and manage interactions of the situational data 220 by one or more user devices 240. The vehicle-generated data management system 202 includes a communication module 204, a vehicle-generated data processing module 206, and a marketplace module 208. The vehicle-generated data management system 202 is associated with one or more vehicles 210 and in communication with one or more user devices 240. The vehicle-generated data management system 202 stores data, such as situational data 220 and vehicle-generated data 230, in or associated with a hybrid cloud system.

A vehicle 210 includes multiple sensors 212 that generate data to monitor and aid in the functioning of the vehicle 210. The vehicle 210 includes a GPS 214 to provide a location of the vehicle 210. The vehicle 210 also includes an interception module 216. The interception module 216 is a component that intercepts data from one or more sensors 212 and generates vehicle-generated data 230. In exemplary embodiments, the interception module 216 is part of the vehicle 210 as an original equipment manufacture component that is capable of communicating with one or more sensors 212 of the vehicle. In some embodiments, the interception module 216 is an add-on component of the vehicle 210 that is inserted into one or more sensory acquisition chains of the vehicle 210. The interception module 216 is a passive on-vehicle acquisition component that intercepts raw data from the one or more sensors 212. The interception module 216 communicates with a GPS 214 of the vehicle 210 to obtain location information of the vehicle 210. The interception module 216 associates the data captured from the sensor 212 and associates it with the location obtained from the GPS 214. In some embodiments, the interception module 216 associates the data from the sensor 212 with a current system time of the vehicle 210. The interception module 216 generates vehicle-generated data 230 that contains the sensor data and associated location and time and transmits the vehicle-generated data 230 to the communication module 204 of the vehicle-generated data system 202. In some embodiments, the interception module 216 continuously generates and transmits vehicle-generated data 230 to the communication module 204 while the vehicle 210 is on or is moving. In some embodiments, the interception module 216 generates and transmits vehicle-generated data 230 to the communication module 204 in response to a request from the communication module 204. In some embodiments, the interception module 216 generates and transmits vehicle-generated data 230 to the communication module 204 in response to new data detected from a sensor 212 of the vehicle 210.

The communication module 204 of the vehicle-generated data management system 202 communicates with one or more devices, such as vehicle 210, that are equipped with an interception module 216. The communication module 204 receives requests from one or more user devices 240 for data. The communication module 204 transmits requests for data to the interception module 216 of the vehicle 210 and receives the vehicle-generated data 230. In some embodiments, the communication module 204 identifies vehicles 210 relevant to a data request, such as vehicles that are entering an identified geographic location and generates requests for data for the identified vehicles 210. In some embodiments, the communication module 204 receives vehicle-generated data 230 from vehicles 210 at periodic intervals or as the vehicle-generated data 230 is generated.

The vehicle-generated data processing module 206 receives and processes the vehicle-generated data 230. In some embodiments, the vehicle-generated data processing module 206 extracts the data obtained from the sensors 212 of the vehicle 210 and the corresponding geographic location of the vehicle 210 provided by the GPS at the time the data from the sensor 212 was obtained and the system time of the vehicle 210 when the data from the sensor 212 was obtained. In some embodiments, the data from the sensor 212 is analyzed for content, associated with one or more categorization tags, and formatted for consumption by one or more requesting user devices 240. In some embodiments, the vehicle-generated data processing module 206 uses the processed vehicle-generated data 230 to generate situational data 220. Situational data 220 is generated by applying one or more machine learning or artificial intelligences techniques to the vehicle-generated data 230 to transform the data from the sensor 212. In some embodiments, situational data 220 is generated using data from multiple devices or vehicles 210, data from devices or vehicles 210 in an identified geographic area, and/or data collected over a predetermined interval of time. The vehicle-generated data processing module 206 transmits the processed vehicle-generated data 230 and the situational data 220 to one or more storage devices. In some embodiments, the storage devices are associated with a hybrid cloud system.

The vehicle-generated data management system 202 also includes a marketplace module 208. The marketplace module 208 communicates with one or more user devices 240. In some embodiments, the marketplace module 208 receives a request from a user device 240 for data. The marketplace module 208 queries the situational data 220 and the vehicle-generated data 230 to identify relevant data. In some embodiments, the request from the user device 240 includes one or more parameters for the data (e.g., geographic location, time of collection, type of data, etc.). In some embodiments, the marketplace module 208 communicates the parameters to the communication module 204. The communication module 204 can generate one or more requests for data using the parameters and transmit the requests for data to one or more vehicles 210. The communication module 204 receives vehicle-generated data 230 from the vehicle(s) 210 responsive to the requests and communicates the vehicle-generated data 230 to the vehicle-generated data processing module 206. The vehicle-generated data processing module 206 processes the vehicle-generated data 230 and/or generates situational data 220 using the parameters from the request from the user device 240. The marketplace module 208 generates a response to the request from the user device 240 indicative of the situational data 220 or the processed vehicle-generated data 230 and communicates with the user device 240. In some embodiments, the marketplace module 208 facilitates access to the requested data (e.g., situational data 220 and/or processed vehicle-generated data 230) for the user device 240.

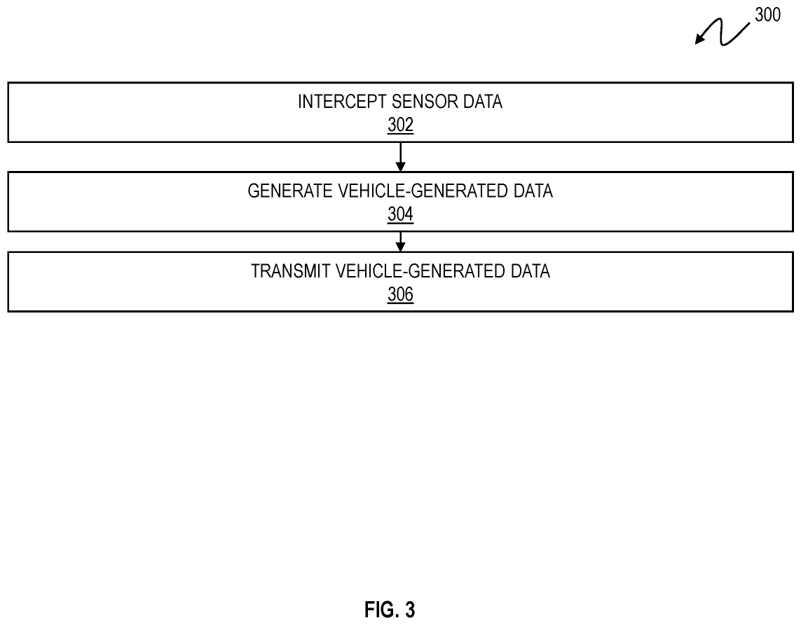

Referring now to FIG. 3, a flowchart of a method 300 for generating vehicle-generated data for a vehicle-generated data management system in accordance with one or more embodiments of the present invention is shown. The method 300 begins at block 302 by intercepting data from one or more sensors 212. In some embodiments, the interception module 216 intercepts data from one or more sensors 212 of a vehicle 210. Examples of data produced, captured, and/or generated by a sensor 212 include, but are not limited to, a temperature measurement of the environment outside of the vehicle 210, an atmospheric pressure near the vehicle 210, a humidity level outside of the vehicle 210, video images (e.g., cameras of the vehicle 210) of the environment outside of the vehicle 210, a speed of the vehicle 210, and the like. In some embodiments, the interception module 216 determines or detects that a sensor 212 has captured or generated data. The interception module 216 intercepts the data from the sensor 212 in response to the determination or detection. In some embodiments, the interception module 216 receives a request for data and identifies one or more sensors 212 associated with the requested data and intercepts data from the sensors 212. In some embodiments, the interception module 216 continuously intercepts all the data from a sensor 212 as it is captured or generated.

The method 300 further includes generating vehicle-generated data, as shown in block 304. The interception module 216 generates vehicle-generated data 230 or a vehicle-generated data stream using the intercepted data from one or more sensors 212. The interception module 216 associates the intercepted data from the sensor 212 with a current geographic location of the vehicle 210 obtained from the GPS 214. In some embodiments, the interception module 216 associates the intercepted sensor data with a current system time of the vehicle 210. The interception module 216 generates vehicle-generated data 230 and prepares the vehicle-generated data 230 for transmittal.

Next at block 306, the method includes transmitting the vehicle-generated data 230. In some embodiments, the interception module 216 transmits the vehicle-generated data 230 in response to a request received from the communication module 204. In some embodiments, the interception module 216 transmits the vehicle-generated data 230 at predetermined intervals of time, when a network connection is available, or upon generation of the vehicle-generated data 230.

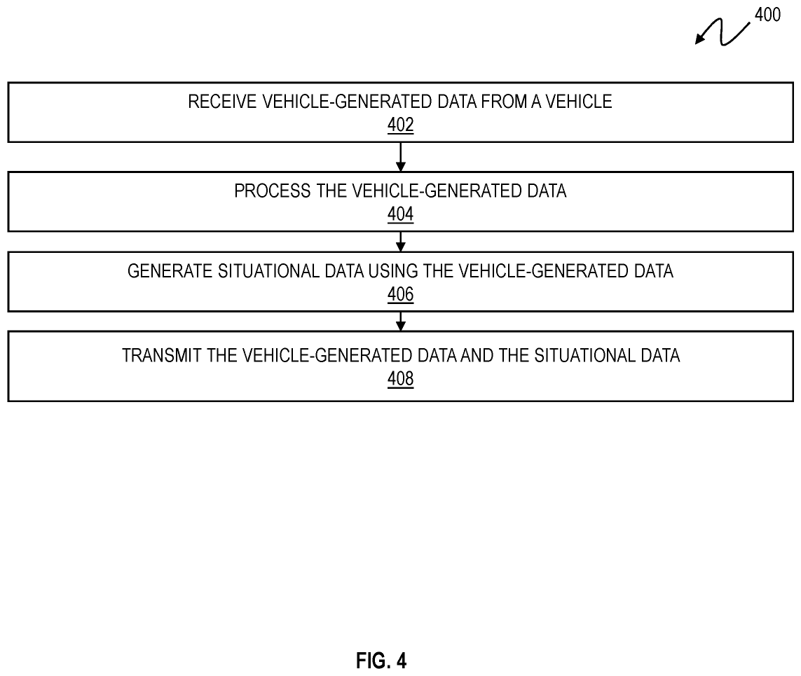

Referring now to FIG. 4, a flowchart of a method 400 for generating situational data using vehicle-generated data for a vehicle-generated data management system in accordance with one or more embodiments of the present invention is shown. The method 400 begins at block 402 by receiving vehicle-generated data 230 from a vehicle 210. The communication module 204 receives the vehicle-generated data 230 from an interception module 216 of a vehicle 210. In some embodiments, the vehicle-generated data 230 is received in response to a request initiated by the marketplace module 208. In some embodiments, the vehicle-generated data 230 is received upon the generation of the vehicle-generated data 230 from the vehicle 210. The communication module 204 communicates the vehicle-generated data 230 to the vehicle-generated data processing module 206.

At block 404, the vehicle-generated data 230 is processed. The vehicle-generated data processing module 206 extracts data from the vehicle-generated data 230. For example, the vehicle-generated data processing module 206 extracts data obtained from sensors 212 of the vehicle 210, geographic location data associated with the data from the sensors 212, a time associated with the data from the sensors 212, and the like. In some embodiments, the vehicle-generated data processing module 206 stores the extracted data in a storage structure, such as a hash table. The vehicle-generated data processing module 206 generates further analyzes the extracted data, generates and associates tags or keywords with extracted data, and stores the tags or keywords in association with the extracted data. In some embodiments, the vehicle-generated data processing module 206 formats the extracted data and associated labels or keywords for consumption by one or more user devices 240.

At block 406, situational data is generated using the vehicle-generated data. In some embodiments, the vehicle-generated data processing module 206 uses one or more machine learning or artificial intelligence techniques to transform the processed vehicle-generated data 230 and generate situational data 220. Situational data 220 can be generated using vehicle-generated data 230 from one or more vehicles 210.

For example, the interception module 216 of a vehicle 210 generates vehicle-generated data 230 using data from a sensor 212 (e.g., cameras of a vehicle). The vehicle-generated data 230 includes images captured by the sensor 212 of the vehicle 210 while traveling on a road. The vehicle-generated data processing module 206 processes the images captured by the sensor 212 by applying computer vision processing to determine that the vehicle 210 is surrounded by a high number of other cars. The vehicle-generated data processing module 206 determines that the vehicle 210 is a highway using the geographic location data obtained from the GPS 214 of the vehicle 210 at the time the images were obtained from the sensor 212.

In some embodiments, the vehicle-generated data processing module 206 receives images captured by a sensor 212 of a different vehicle 210 traveling along the same road as the first vehicle. The vehicle-generated data processing module 206 processes the images captured by the sensor 212 of the second car and determines that the second vehicle 210 is also currently located on a highway and surrounded by other cars. The vehicle-generated data processing module 206 uses the processed vehicle-generated data 230 from both vehicles 210 to generates situational data 220 indicating that the section of the highway where the vehicles 210 are currently located is experiencing a high level of traffic.

At block 408, the vehicle-generated data and the situational data are transmitted. In some embodiments, the vehicle-generated data processing module 206 transmits the processed vehicle-generated data 230 and/or the situational data 220 to one or more storage devices. The storage devices may be part of a hybrid cloud system. In some embodiments, the vehicle-generated data processing module 206 communicates with the marketplace module 208 to indicate that vehicle-generated data 230 has been processed or situational data 220 has been generated. In some embodiments, the marketplace module 208 communicates with one or more user devices 240 to notify the user devices 240 that the processed vehicle-generated data 230 and/or situational data 220 is available for consumption.

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

One or more of the methods described herein can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

In some embodiments, various functions or acts can take place at a given location and/or in connection with the operation of one or more apparatuses or systems. In some embodiments, a portion of a given function or act can be performed at a first device or location, and the remainder of the function or act can be performed at one or more additional devices or locations.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The present disclosure has been presented for purposes of illustration and description but is not intended to be exhaustive or limited to the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

The diagrams depicted herein are illustrative. There can be many variations to the diagram, or the steps (or operations) described therein without departing from the spirit of the disclosure. For instance, the actions can be performed in a differing order or actions can be added, deleted or modified. Also, the term “coupled” describes having a signal path between two elements and does not imply a direct connection between the elements with no intervening elements/connections therebetween. All of these variations are considered a part of the present disclosure.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method comprising:
receiving vehicle-generated data from a vehicle associated with a vehicle-generated data management system;
processing the vehicle-generated data to extract sensor data, GPS data, and time data;
generating situational data using the sensor data, the GPS data and the time data; and
transmitting the situational data and the processed vehicle-generated to a hybrid cloud system.

2. The computer-implemented method of claim 1, further comprising:
intercepting sensor data from a sensor of the vehicle; and
generating the vehicle-generated data by associating the sensor data with a current time and a current GPS location of the vehicle.

3. The computer-implemented method of claim 1, further comprising:
transmitting a request for the vehicle-generated data from the vehicle; and
receiving the vehicle-generated data from the vehicle in response to the request.

4. The computer-implemented method of claim 3, further comprising:
receiving a notification that the vehicle is in an identified geographic area; and
transmitting the request for the vehicle-generated data of the vehicle in response to receiving the notification.

5. The computer-implemented method of claim 1, further comprising:
receiving a request for data associated with an identified location from a user device;
retrieving a set of processed vehicle-generated data from the hybrid cloud system;
in response to the request, generating new situational data using the set of processed vehicle-generated data; and
transmitting the new situational data to the user device.

6. The computer-implemented method of claim 1, wherein processing the vehicle-generated data further comprises:
analyzing content of the vehicle-generated data;
extracting the sensor data, the GPS data, and the time data from the vehicle-generated data; and
associating one or more category tags with the vehicle-generated data.

7. The computer-implemented method of claim 1, further comprising:
receiving additional vehicle-generated data from a different vehicle;
processing the additional vehicle-generated data;
generating additional situational data using the additional vehicle-generated data; and
generating a set of situational data comprising the situational data and the additional situational data based on an identified GPS location or an identified time; and
transmitting the set of situational data to the hybrid cloud system.

8. A system comprising:
a memory having computer readable instructions; and
one or more processors for executing the computer readable instructions, the computer readable instructions controlling the one or more processors to perform operations comprising:
receiving vehicle-generated data from a vehicle associated with a vehicle-generated data management system;
processing the vehicle-generated data to extract sensor data, GPS data, and time data;
generating situational data using the sensor data, the GPS data and the time data; and
transmitting the situational data and the processed vehicle-generated to a hybrid cloud system.

9. The system of claim 8, wherein the operations further comprise:
intercepting sensor data from a sensor of the vehicle; and
generating the vehicle-generated data by associating the sensor data with a current time and a current GPS location of the vehicle.

10. The system of claim 8, wherein the operations further comprise:
transmitting a request for the vehicle-generated data from the vehicle; and
receiving the vehicle-generated data from the vehicle in response to the request.

11. The system of claim 10, wherein the operations further comprise:
receiving a notification that the vehicle is in an identified geographic area; and
transmitting the request for the vehicle-generated data of the vehicle in response to receiving the notification.

12. The system of claim 8, wherein the operations further comprise:
receiving a request for data associated with an identified location from a user device;
retrieving a set of processed vehicle-generated data from the hybrid cloud system;
in response to the request, generating new situational data using the set of processed vehicle-generated data; and
transmitting the new situational data to the user device.

13. The system of claim 8, wherein the operations to process the vehicle-generated data further comprises:
analyzing content of the vehicle-generated data;
extracting the sensor data, the GPS data, and the time data from the vehicle-generated data; and
associating one or more category tags with the vehicle-generated data.

14. The system of claim 8, wherein the operations further comprise:
receiving additional vehicle-generated data from a different vehicle;
processing the additional vehicle-generated data;
generating additional situational data using the additional vehicle-generated data; and
generating a set of situational data comprising the situational data and the additional situational data based on an identified GPS location or an identified time; and
transmitting the set of situational data to the hybrid cloud system.

15. A computer program product comprising a computer readable storage medium having program instructions embodied therewith, the program instructions executable by a processor to cause the processor to perform operations comprising:
receiving vehicle-generated data from a vehicle associated with a vehicle-generated data management system;
processing the vehicle-generated data to extract sensor data, GPS data, and time data;
generating situational data using the sensor data, the GPS data and the time data; and
transmitting the situational data and the processed vehicle-generated to a hybrid cloud system.

16. The computer program product of claim 15, wherein the operations further comprise:
intercepting sensor data from a sensor of the vehicle; and
generating the vehicle-generated data by associating the sensor data with a current time and a current GPS location of the vehicle.

17. The computer program product of claim 15, wherein the operations further comprise:
transmitting a request for the vehicle-generated data from the vehicle; and
receiving the vehicle-generated data from the vehicle in response to the request.

18. The computer program product of claim 17, wherein the operations further comprise:
receiving a notification that the vehicle is in an identified geographic area; and
transmitting the request for the vehicle-generated data of the vehicle in response to receiving the notification.

19. The computer program product of claim 15, wherein the operations further comprise:
receiving a request for data associated with an identified location from a user device;
retrieving a set of processed vehicle-generated data from the hybrid cloud system;
in response to the request, generating new situational data using the set of processed vehicle-generated data; and
transmitting the new situational data to the user device.

20. The computer program product of claim 15, wherein to process the vehicle-generated data the operations further comprise:
analyzing content of the vehicle-generated data;
extracting the sensor data, the GPS data, and the time data from the vehicle-generated data; and
associating one or more category tags with the vehicle-generated data.
